(19) United States
(12) Patent Application Publication
(10) Pub. No.: US 2013/0113234 A1
(43) Pub. Date: May 9, 2013

(54) Automatic Window Cover

(71) Applicant: Eliyahu Horowitz, Fresh Meadows, NY (US)

(72) Inventor: Eliyahu Horowitz, Fresh Meadows, NY (US)

(21) Appl. No.: 13/290,103

(22) Filed: Nov. 6, 2011

(51) Int. Cl. B60J 3/00

(52) U.S. Cl. 296/97.4

(57) ABSTRACT

An Automatic Window Cover of the invention allows a vehicle user to activate motorized window shades that may include a reflective surface to reflect light that may otherwise cause the vehicle to heat up.

### CROSS-REFERENCE TO RELATED APPLICATIONS

Not Applicable

### STATEMENT REGARDING FEDERALLY SPONSERED RESEARCH OR DEVELOPMENT

Not Applicable

### REFERENCE TO SEQUENCE LISTEING, A TABLE, OR A COMPUTER PROGRAM LISTING COMPACT DISC APPENDIX

Not Applicable

### BACKGROUND OF THE INVENTION

Warm temperature and sunlight have been known to raise the internal temperature of a stationary car. To address this issue, some car users have placed reflective materials under the windshield of a car as a means to reflect heat away from the car. This is often viewed as a cumbersome task and only available for the windshield.

### BRIEF SUMMARY OF THE INVENTION

An Automatic Window Cover of the invention is a window cover that uses a motor to position itself over a window. The user can activate the motor to cover the window or retract from it. The cover and motor can be mounted on a window or inside of the car frame for a more durable, aesthetic and less cumbersome design.

### BRIEF DESCRIPTION OF THE SEVERAL VIEWS OF THE INVENTION

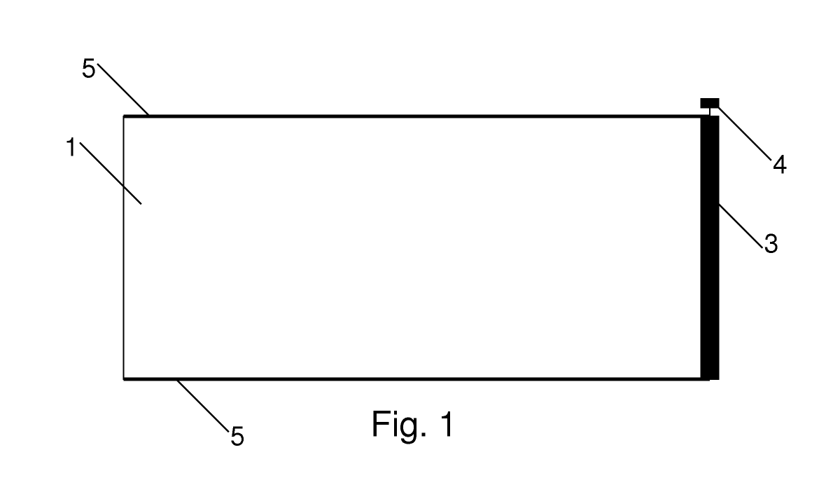

FIG. 1 is a front view of a rolled in window shade of a Automatic Window Cover of the invention.

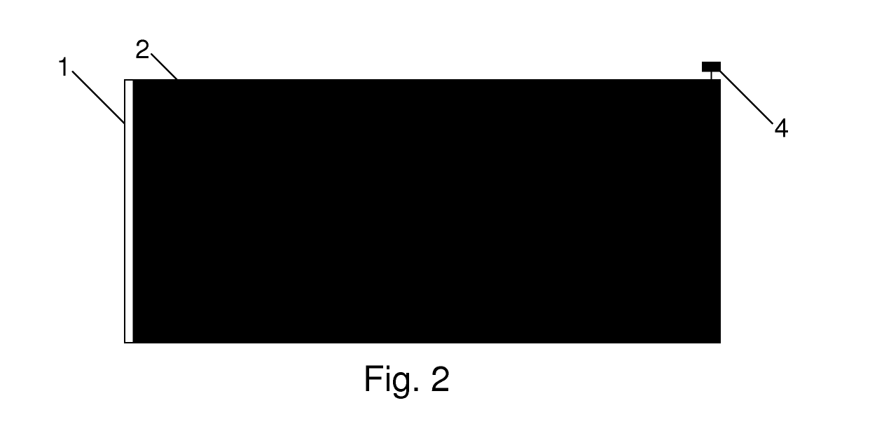

FIG. 2 is a front view of a rolled out window shade of a Automatic Window Cover of the invention.

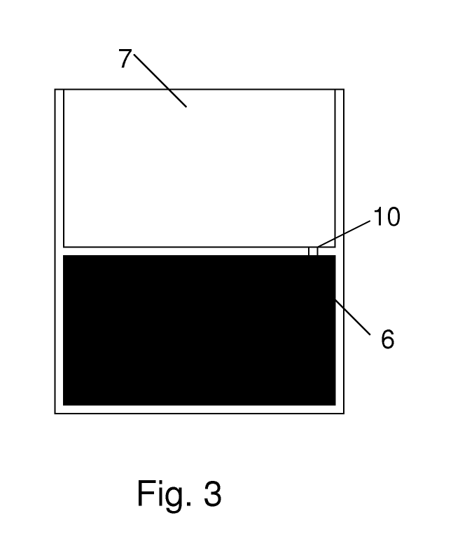

FIG. 3 is a front view of a retracted window shade of a Automatic Window Cover of the invention.

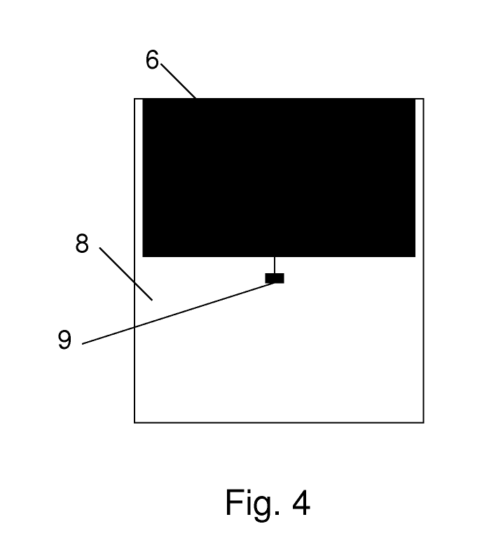

FIG. 4 is a front view of a utilized window shade of a Automatic Window Cover of the invention.

### DETAILED DESCRIPTION OF THE INVENTION

An Automatic Window Cover of the invention can utilize a rolled up window shade 3 as seen in FIG. 1. The rolled up window shade 3 should be lined up with the window 1. When the user activates the motor 4 the rolled up window shade 3 becomes the rolled out window shade 2 as seen in FIG. 2. To keep the shade aligned with the window one or plurality of track 5 may be used.

Another Automatic Window Cover of the invention can use a rigid or flexible window cover 6 as seen in FIG. 3. A rigid or flexible window cover 6 is similar to a standard car window and may be housed within the car frame 8. When the motor 9 is activated, the rigid or flexible window cover 6 covers the adjacent window 7, as seen in FIG. 4. Activation of a motor can be done by a switch 10 from one or a plurality of locations in a vehicle.

What is claimed is:

1. A vehicle window cover comprising:
a motorized rolled up cover that can roll out and in; and a means for motor activation.

2. A cover as in claim 1 further comprising a reflective surface.

3. A cover as in claim 1 further comprising a track to guide the cover across the window space.

4. A cover as in claim 3 further comprising a reflective surface.

5. A vehicle window cover comprising:
a motorized cover that extends and retracts from within the car; and a means for motor activation.

6. A cover as in claim 5 further comprising a reflective surface.
